(19) United States
(12) Patent Application Publication
(10) Pub. No.: US 2026/0254821 A1
(43) Pub. Date: Aug. 27, 2026

(54) CENTRALIZED ANOMALY AWARENESS SYSTEM AND METHOD

(71) Applicant: Varonis Systems, Inc., New York, NY (US)

(72) Inventors: John NEYSTADT, Kfar Saba (IL); Rami CITROM, Herzliya (IL)

(21) Appl. No.: 19/064,457

(22) Filed: Feb. 26, 2025

(51) Int. Cl. H04L 9/40

(52) U.S. Cl. CPC H04L 63/1416

(57) ABSTRACT

Disclosed is a system and method for protecting a local computer network from anomalous network behavior based on remote centralized anomaly detection. A local system aggregates and reports similar network-related events performed during a predetermined period of time at a computer network to a remote centralized analytics server when the number of events satisfies a first threshold. The local system receives an indication of an additional aggregation of the similar network-related events performed at one or more different computer networks from the server, and determines the events constitute an anomaly based on the sum of the aggregated network-related events and the additional aggregation satisfying a second threshold number of events. A remediation action is then selected and performed to protect the computer network.

### TECHNICAL FIELD

The present invention relates to protecting computer networks from anomalous network behavior.

### BACKGROUND

Enterprise data systems and computer networks manage high volumes of critical and sensitive information. Ensuring the integrity and security of this data—and data of its users—is essential, as irregular patterns—such as unauthorized access attempts, denial of service attacks, and abnormal usage—are becoming common threats faced by modern organizations. However, besides the availability and use of standardized anomaly detection tools, how those tools are configured to perform anomaly detection has traditionally been the responsibility of each local organization. Accordingly, organizations are often unprepared to respond to widespread externally introduced anomalies. Conventional systems have no way to obtain a global view of an overall complex global attack, and organizations have been reluctant to share data with other organizations, even after such attacks. Moreover, data locality laws may restrict export of raw or sensitive data outside of jurisdictional borders, thus hampering a multi-national organization's detection of attack patterns spanning multiple jurisdictions, even when directed at the same organization.

### SUMMARY

According to various aspects, the subject technology addresses the limitations of existing approaches to anomaly detection by providing a centralized anomaly awareness system. This centralized system is configured to collect events world wide, and detect patterns of attacks spanning multiple organizations and/or jurisdictions. The disclosed system facilitates distributed hierarchical incident detection that allows local organizations to retain control of their data, prevent the sharing of raw data between organizations and/or jurisdictions, and compliance with data locality laws.

The disclosed centralized computer system receives anonymous event data from local systems, aggregates the data, and performs event analysis for the local satellite detection systems in a centralized location, calculates features and feeds them to a model to determine whether events in different jurisdictions are related. In this manner, globally systemic attacks may be detected earlier than if a single local system was used. This technology significantly enhances the efficiency and effectiveness of identifying, classifying, and understanding anomalies, potentially offering improved threat detection and response times. Moreover, communication between the centralized system and local jurisdictions are anonymized, alleviating cross-jurisdictional privacy concerns.

In particular, a machine-implemented method for protecting a local computer network from anomalous network behavior based on remote centralized anomaly detection is disclosed. According to various aspects, the subject technology comprises a computer-implemented method for protecting a computer network from anomalous network behavior, comprising: aggregating similar network-related events performed during a predetermined period of time at a computer network and that pertain to actions originating from outside the computer network; reporting the aggregated network-related events to a remote centralized analytics server when the aggregated network-related events satisfies a first threshold number of events; receiving, from the remote centralized analytics server, an indication of an additional aggregation of the similar network-related events performed at one or more different computer networks; determining an anomaly based on a sum of the aggregated network-related events and the additional aggregation satisfying a second threshold number of events; automatically selecting a remediation action to be performed with regard to the computer network based on the determined anomaly and a predetermined policy; and automatically performing the remediation action to protect the computer network. Other aspects include corresponding systems, apparatus, and computer program products for implementation of the corresponding method and its features.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

For a better understanding of the various described implementations, reference should be made to the Description of Implementations below, in conjunction with the following drawings. Like reference numerals refer to corresponding parts throughout the figures and description.

FIG. 1 depicts a block diagram of a local anomaly detection system for protecting a local computer network from anomalous network behavior, according to aspects of the subject technology.

FIG. 2 depicts a block diagram of a system for protecting local computer networks from anomalous network behavior using a centralized anomaly awareness system, according to aspects of the subject technology.

FIG. 3 depicts a first example process flow diagram for protecting local computer networks from anomalous network behavior using a centralized anomaly awareness system, according to aspects of the subject technology.

FIG. 4 depicts a second example process flow diagram for protecting local computer networks from anomalous network behavior using a centralized anomaly awareness system, according to aspects of the subject technology.

FIG. 5 is a conceptual diagram illustrating an example electronic system for protecting local computer networks from anomalous network behavior using a centralized anomaly awareness system, according to aspects of the subject technology.

### DESCRIPTION

Reference will now be made to implementations, examples of which are illustrated in the accompanying drawings. In the following description, numerous specific details are set forth in order to provide an understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

The subject technology addresses the challenge of responding to widespread externally introduced anomalies, particularly those that aim to threaten the security of an organization's computer network and related components. The system and method described herein includes a hierarchical analytical system that integrates a remote centralized anomaly detection system with multiple local anomaly detection systems to improve anomaly detection performance, including response times, and to provide valuable insights into the nature of detected anomalies. Each local anomaly detection system may be deployed in its own geographical or organizational jurisdiction, while the centralized anomaly detection system can be deployed in a single geographical or organizational jurisdiction to receive data from each local system, to provide centralized analytics and anonymized responses to broaden anomaly awareness at the local level while mitigating organizational privacy and/or data locality concerns.

Each local anomaly detection system collects and aggregates similar network-related events that are identified during a predetermined period of time at the local organization's computer network, and reports the aggregation to the centralized anomaly detection system. Each connected local system also receives (e.g., periodically) an indication of additional aggregations of those network-related events which were identified at one or more different computer networks. The local systems may then determine whether the combination of the (aggregated) locally seen network-related events together with the additional aggregations constitute an anomalous threat that should be addressed locally. A remediation action may then be selected and performed to protect the local organization's computer network.

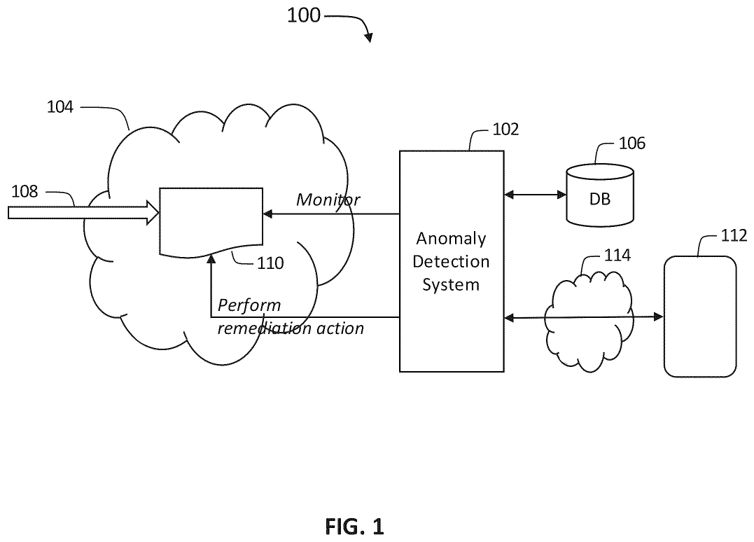

FIG. 1 depicts a block diagram of a local anomaly detection system for protecting a local computer network from anomalous network behavior, according to aspects of the subject technology. Anomaly detection system 102 monitors a network 104 for anomalies. In this regard, the anomaly detection system 102 may be designed to integrate seamlessly with one or more network and data monitoring systems—including, but not limited to a Network Intrusion Detection System (NIDS) or an Intrusion Detection and Prevention Systems (IDPS) to enhance the detection and analysis, and categorization, of network and data anomalies (including, e.g., denial of service attacks). In some implementations, the anomaly detection system may integrate with a Security Information and Event Management (SIEM) systems, Data Loss Prevention (DLP) systems, Endpoint Detection and Response (EDR) solutions, Email Security Gateway (ESG) or Secure Email Gateways (SEG), Advanced Threat Protection (ATP) systems, and Network Traffic Analysis (NTA) platforms. The anomaly detection system 102 may interface with these such, for example, through configurable APIs and adapters, allowing it to ingest and analyze data from a variety of sources such as network packets, logs, document metadata, emails, and file contents.

The anomaly detection system 102 may include one or more servers (or group of servers), and may include and/or employ one or more sensors (deployed, e.g., as dedicated hardware or software) that are configured to capture and analyze network traffic for anomalies. According to various implementations, the anomaly detection system 102 includes one or more processors, memory and/or storage devices, network interfaces, with which it is configured to process traffic and apply rule sets to detect intrusions. In some implementations, a separate database server 106 stores logs and alerts, while a management console provides administrative oversight. Database server 106 may include, for example, a centralized database, local or networked file system, model registry, cloud storage, model container, embedded memory, registry, or any other storage system capable of storing large data sets.

The anomaly detection system 102 monitors data streams transmitted through the network 104 for potentially anomalous events. For example, the anomaly detection system 102 may monitor network connections to identify abnormal (e.g., high number of) requests from a single network address (e.g., IP) or repeated requests to a specific endpoint. Potentially anomalous events may be identified based on actions 108 that originate from outside the computer network 104 and how those actions interact with a monitored component 110 (e.g., hardware or data) of the network 104. The anomaly detection system 102 may determine, in real time, whether a remediation action should be taken to protect the computer network 104 (including, e.g., component(s) 110) from further events.

As will be described further, the anomaly detection system 102 connects to a centralized anomaly awareness system 112 (e.g., over the Internet or second network 114) to obtain a global awareness as to whether the same or similar anomaly is occurring on other systems. In this regard, the anomaly detection system 102 may determine whether to consider events occurring locally to be anomalous based on an aggregation of the local events and events identified by the centralized anomaly awareness system 112. A remediation action to be performed with regard to the local computer network 104 may then be selected based on the type of the anomaly and a predetermined policy, and performed to protect the compute network.

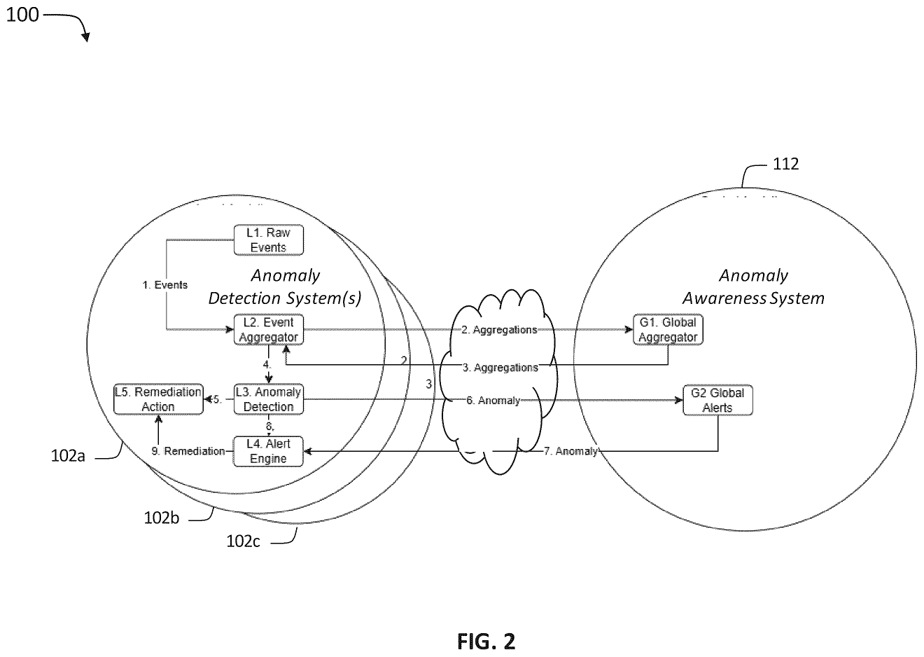

FIG. 2 depicts a block diagram of a system for protecting local computer networks from anomalous network behavior using a centralized anomaly awareness system, according to aspects of the subject technology. In the depicted example, multiple local anomaly detection systems 102a-c are configured to interface with a centralized anomaly awareness system 112. Each anomaly detection system 102 may configured to detect anomalies on a respective organization's network. In this regard, each system 102 may be geographically remote from each other and operate independently of each other, for example, in the same manner as the organization it protects operates independently of other organizations.

Each anomaly detection system 102 collects (1) local raw events L1, which are provided to a local event aggregator L2. In some implementations, the events are collected by an integrated NIDS or IDPS. The event aggregator L2 may aggregate the collected events according to predetermined rules. For example, event aggregator L2 may aggregate (or group) all events of a same type (e.g., connection request, failed login attempt, scrapping activity, etc.) that occurs within a predetermined window of time and/or that originate from a same entity (determined, e.g., by the originator's network address). The aggregation produced by event aggregator L2 may then be sent (2), in real time, to a global aggregator G1 at the centralized anomaly awareness system 112.

In some implementations, the aggregation of events includes certain information including, for example, an identification of the event type and/or an identification of the entity (or entities) responsible for the actions causing the events (e.g., a source network address, or user-agent identifier, etc.). In some implementations, the event aggregator L2 may count events and provide the aggregation as a numerical count (e.g., for failed login attempts, connection requests, etc.). In some implementations, the aggregation may include a signal that a threshold was passed. For example, the local event aggregator L2 may count events and send, as the aggregation, a notification or signal indicating that the threshold was satisfied. In some implementations, the aggregation (or notification) may include a last access time (e.g., of all attempts). According to various implementations, the event aggregations may be anonymized, thus alleviating privacy concerns of moving the raw data across jurisdictions or organizations.

The global aggregator G1 of the centralized anomaly awareness system 112 receives aggregated network-related events from multiple local anomaly detection systems 102a-c and performs a second level aggregation of all aggregations received from the various connected local anomaly detection systems 102a-c. In this regard, the global aggregator G1 may not see raw events, but only the aggregations sent (2) to it by the local event aggregator L2. These second level aggregations may be aggregated by type, entity, window of time, etc. For example, where the aggregations sent by each event aggregator L2 are counts, the second level aggregations may include a total running count of all counts that pertain to the same type, entity, window of time, etc. that are received from all connected local event aggregators L2.

The global aggregator G1 then distributes the aggregations of similar network-related events back (3) to the local anomaly detection systems 102a-c. In this regard, each local anomaly detection system 102 can not only account for what events (as aggregations) it sees locally, but also what events (as represented by aggregations) that other organizations have seen. Accordingly, if a global attack on networks is occurring around the world, local anomaly detection systems 102 that have not yet been subject to the attack may account for the attack by way of being informed by the global aggregator G1 (which received indications from other local systems), and react accordingly (by way of a remediation action).

According to some implementations, the distributed aggregations sent back (3) to each local event aggregator L2 (of each respective anomaly detection system 102a) may only include data from other anomaly detection systems 102b-c (local event aggregators L2), and exclude data that was collected from the same local anomaly detection systems 102a to avoid double counting. In this regard, the global aggregator G1 may keep track of aggregations provided to it by each connected local event aggregator L2 and deduct those aggregations from a running total when it sends aggregations back (3) to the level event aggregator L2, or may maintain a running total for each connected event aggregator L2. According to various implementations, the global aggregator G1 may send back (3) return aggregations of similar network-related events periodically, which may or may not be based on a time in which the aggregations were received by the global aggregator G1. In this regard, where the aggregations include a running count of events, the running count or an updated running count may be sent (3) periodically to each connected local event aggregator L2.

As shown in the depicted example, each anomaly detection system 102 includes an anomaly detection module/engine L3. The aggregations seen locally as well as the aggregations seen by other organization (received via the global aggregator G1) are sent (4) to the anomaly detection module L3 and, according to various implementations, the anomaly detection engine L3 determines whether the event aggregation satisfies a threshold to be considered an anomaly that should be addressed by the anomaly detection system 102. Indicators and context pertaining to the anomaly may also be sent. For example, the number of locally detected connection attempts may be sent together with a number of connection attempts received by other organizations, as well as an indication of each organizations (e.g., 350 from organization A, and 300 from organization B) via the global aggregator G1. Such information may provide traceable identification of who reported the events originally, and how the aggregate happened.

In some implementations, the anomaly detection engine L3 may determine whether the threshold is satisfied based on the sum of the aggregated network-related events determined by the local event aggregator L2 and the additional aggregation provided by the global event aggregator G1. In some implementations, the anomaly detection engine L3 may include a Machine Learning Model, Large Language Model, rule engine, or statistical algorithms such as linear regressions to detect anomalies. A model may be trained over time to determine whether a particular aggregation of events of a particular event type should or should not be considered an anomaly and by what parameters and/or thresholds should be met before an anomaly is detected.

In some implementations, depending on a predetermined policy of the local organization, the anomaly detection engine L3 may determine (e.g., based on the type of anomaly) that a remediation action should be performed to protect the local computer network (or component 110 thereof) when the threshold is satisfied. In such cases, the anomaly detection engine L3 may instruct (5) a remediation action engine L5 to perform the remediation action. The particular remediation action to be performed may be selected based on various factors, including the type of anomaly, the type of events that led up to the anomaly, and the nature of the threat. Where the network-related events include numerous requests from a common network address, the remediation action may include configuring a firewall associated with the computer network to block connection attempts originating from the source network address. Where each network-related event includes a user access to a number of sensitive files, the remediation action may include preventing further user access. Where each network-related event comprises a failed attempt to login to a same user account, the remediation action may include blocking further login attempts to the same user account.

Each local organization may react to the anomaly differently based on what it is seeing in combination with what the centralized anomaly awareness system 112 is seeing. For example, local remediation action may block the IP address of an attacker but also report the IP address (and the anomaly; e.g., numerous superfluous requests, denial-of-service, etc.) to the global engine. When reported to all other local organizations, they may also block the network address on their firewall as soon as it starts attacking them. One organization may detect only 50 connection attempts from a particular network address, which may not cross the threshold for a DoS attack. It may then communicate the 50 attempts to the global aggregator G1. Another organization may also report 50 connection attempts to the global aggregator G1, and a third may also report some attempts. Together, all of the attempts may cross the threshold set by the anomaly detection engine L3. The global aggregator G1 sends the total combined attempts to each local aggregator so that even a single connection attempt from the network address will be seen as an attack. The local anomaly detection engine L3 does not need to see the threshold locally to consider it to be an attack.

According to various implementations, when an anomaly is detected, the anomaly detection engine may also report (6) the identified anomalies to a global alerts engine G2. The global alerts engine G2 may keep a running account of identified anomalies across all connected local anomaly detection systems 102, and can then report (7) the anomalies identified to it back to each of local anomaly detection systems 102. In some implementations, it may also anonymously report the type of organization reporting the anomaly.

The anomaly detection system 102 may further include a local alert engine L4, which may receive (8) the detected anomaly from the local anomaly detection engine L3 as well as the anomalies from (7) the global alerts engine G2. The anomalies may be provided together with information pertaining to the aggregations and/or events (e.g., type, responsible entity, window of time, etc.). The local alert engine L4 intakes local (8) and global (7) anomalies, processes them according to its local polices, which can be different for each local analytic and triggers local remediation actions.

According to various implementations, the global alerts engine G2 shares alerts in an anonymized way. For example, the source organization that reported the alert may be anonymized. For example, the global alerts engine G2 may report that there were 110 events that led to a particular anomaly and that 3 systems were impacted, but the names of the local organizations/systems may be anonymized to preserve the anonymity of each local organization. As another example, there may be 3 DoS attacks on a particular bank. The global alerts engine G2 may report the attacks were directed toward a bank but may not name the bank.

In this regard, each local anomaly detection system 102 can learn what anomalies are being detected on a wider scale, without the need to know which particular organization is being affected by the anomaly. It may be enough to know that an organization of the same type is being affected worldwide. In this regard, the alert engine L4 (based on a predetermined local policy) can immediately react to the anomaly by performing a selected remediation action in anticipation of protecting the organization from the anomaly.

Turning back to step 8, the anomaly detection engine L3 may report to the alert engine L4 that it sees an anomaly based on aggregations by the local event aggregator L2. For example, the event aggregator L2 may report (4) over 100 k connection attempts/sec, and the anomaly detection engine L3 may determine (e.g., based on a further aggregation of connection attempts reported (3) from the global aggregator G1) that these events constitute DoS attacks. The alert engine L4 also receives (7) reports of anomalies from other systems, for example, that other organizations are seeing a DoS attack from a certain IP(s).

The alert engine L4 may include a policy of how to react to alerts, either raised from the local anomaly detection or global anomaly detection, or the combination of both. In some implementations, the alert engine L4 may respond similarly to both reports. In some implementations, an alert may only be reported (7) by the global alerts engine G2. In other words, the attack may not been seen locally. Based on a predetermined local policy, the alert engine L4 may react by blocking the network address of the entity identified as causing the anomaly for a predetermined period of time (e.g., 1 hour). In this regard, the reporting by the global alerts engine G2 may not be necessarily connected to the reporting of the global aggregator G1 in terms of how a local system reacts.

Also, the alert engine L4, in receiving information from both the anomaly detection engine L3, as well as the global alerts engine G2, can respond to locally detected anomalies or globally reported anomalies. In in this regard, if the centralized anomaly awareness system 112 is not available for a period of time, the local anomaly detection system 102 can detect anomalies, raise events and remediate them locally, without dependency on global analytics (which are often located in a different data center).

While the anomaly detection system 102 and the anomaly awareness system 112 and their relevant functions are described separately herein, the functionality of these systems may be incorporated into a single system or server(s) or group of servers. In this regard, the systems may co-exist on the same servers. For example, according to some implementations, data pertaining to a local anomaly detection system 102 and data pertaining to the centralized anomaly awareness system 112 may be stored in the same database, cloud storage, local or networked file system and the like. For example, a single system may operate as both a local anomaly detection system 102 and a centralized anomaly awareness system 112 for other remote anomaly detection systems 102.

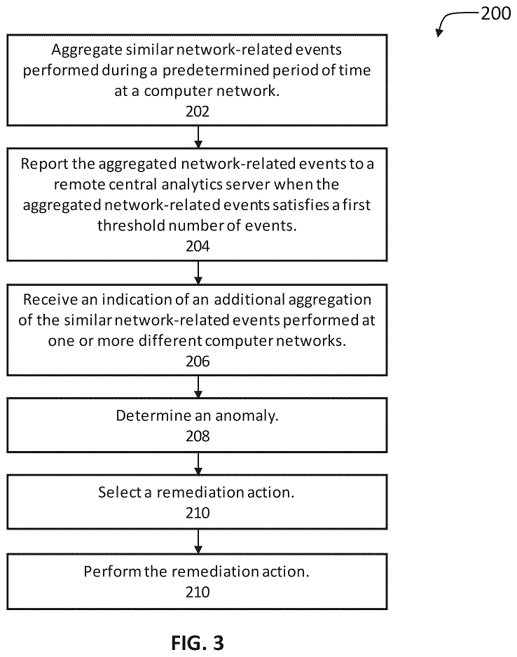

FIG. 3 depicts a first example process flow diagram for protecting local computer networks from anomalous network behavior using a centralized anomaly awareness system, according to aspects of the subject technology. For explanatory purposes, the various blocks of example process 200 are described herein with reference to FIGS. 1 and 2, and the components and/or processes described herein. In some implementations, one or more of the blocks may be implemented apart from other blocks, and by one or more different processors (including virtual processors) or devices. Further for explanatory purposes, the blocks of example process 200 are described as occurring in serial, or linearly. However, multiple blocks of example process 200 may occur in parallel. In addition, the blocks of example process 200 need not be performed in the order shown and/or one or more of the blocks of example process 200 need not be performed.

One or more of the blocks of process 200 may be implemented, for example, by one or more servers or computing devices, such as a server or other device associated with the disclosed system for protecting local computer networks from anomalous network behavior. As described previously, the subject technology includes a collaboration between one or more local anomaly detection systems 102 and a centralized awareness system 112, which may be remote (and separated) from the local anomaly detection systems 102. Each local anomaly detection system 102 may include one or more analytics servers configured with one or more modules/engines to perform the detection of events (e.g., an event monitor module L1), aggregation (e.g., an event aggregator module L2), anomaly detection (e.g., an anomaly detection module L3), generation of alerts (e.g., an alert module L4), and remediation actions (e.g., a remediation action module L5) to protect the network. Such modules/engines may be implemented as electronic hardware, computer software, or combinations of both. Similarly, the anomaly awareness system incudes one or more remote centralized analytics servers configured with modules/engines to perform global aggregation (e.g., a global aggregator module G1) and to generate global alerts (e.g., global alerts module G2). While the modules are described separately, some implementations may combine the functionality of the modules into one or more modules or provide the functionality without reference to individual modules.

In the depicted example, a local analytics server (e.g., as part of a local anomaly detection system 102) aggregates similar network-related events identified during a predetermined period of time as occurring at a computer network (202). As described herein, events pertain to and/or capture actions originating from outside the computer network that could have a detrimental effect on the network or data therein. Event types may include, for example, connection requests, port scan requests, malformed packet(s) received, excessive requests from a single network (IP) address, unusual outbound traffic, unauthorized API request, repeated authentication failure or failed login request, unexpected data exfiltration attempt, unsuccessful session establishment, network reconnaissance attempts, and the like. Events pertaining to network reconnaissance attempts may also be identified, including probing ports or services, or identifying active hosts, pings or ping sweep requests (e.g., sending echo requests to identify active hosts), traceroute requests (e.g., mapping the path to a network to understand topology), DNS queries, service enumeration requests, and the like. Accordingly, the local analytics server may identify events in which an external entity may be trying to gather information about the computer network, typically before an attack, so that the anomaly detection system 102 can remediation actions to protect the network before the attack occurs.

As described previously, the aggregation may include a count of the events over a predetermined period time, or window of time (e.g., last hour). The local analytics server reports the aggregated network-related events to a remote centralized analytics server (e.g., as part of the centralized anomaly awareness system 112) when the aggregated network-related events satisfies a first threshold number of events (204). In some implementations, the reporting of the events includes reporting an identification of one or more entities responsible for the actions originating from outside the computer network. The identification that is reported may include, for example, a network address (e.g., an IP address) obtained from the incoming connection request or header of the network transmission that initiated the event.

The local analytics server receives, from the remote centralized analytics server, an indication of an additional aggregation of the similar network-related events performed at one or more different computer networks (206). As previously described, this additional aggregation may include a count of events of the same type received by other servers of other organizations. In this manner, the local analytics server is made aware of external activity that is indicative a wider attack on computer networks, generally, and can factor that activity in its analysis of whether to respond locally.

Based on the aggregations, the local analytics server determines whether an anomaly has occurred (208) that should be addressed. In some implementations, the server determines an anomaly based on a sum of the aggregated network-related events and the additional aggregation satisfying a second threshold number of events. According to various implementations, the second threshold is greater than the first threshold (particularly for like anomalies).

The anomaly detection system 102 then automatically selects a remediation action to be performed with regard to the computer network based on the determined anomaly and a predetermined policy (208), and the remediation action is automatically performed (210) to protect the computer network. In some implementations, the remediation action may be selected (and performed) by an integrated intrusion prevention system or network security appliance(s) or software. In some implementations, the remediation action may be selected based on, in part, the one or more incidents being reported by the one or more other anonymous organizations. For example, the predetermined policy may include a rule that, if a certain number of anomalies representative of attacks on the other computer networks are being reported by external organizations may temporarily (e.g., for 1-2 hours) lock down certain ports on a local firewall or block the network address associated the anomalies.

In some implementations, prior to selecting and/or performing the remediation action, the anomaly detection system 102 (e.g., the local analytics server) may report a determined anomaly to the remote centralized analytics server. Also, the remote centralized analytics server may periodically provide the anomaly detection system 102 an indication of one or more incidents of the determined anomaly being reported by other anomaly detection systems (e.g., from one or more other organizations geographically remote from the computer network). As described previously, the anomalies may be provided with contextual information about where the anomalies occurred. For example, instead of naming the other organization that was under a denial of service attack, the centralized analytics server may describe the type of anomalous events that occurred and where the events originated (e.g., source IP) but anonymize the organization. In this regard, the anomaly detection system can generate a notification (e.g., to be provided with or alternative to a remediation action) that includes information pertaining to the one or more incidents of the determined anomaly being reported by the one or more anonymous other organizations. Accordingly, the remediation action may automatically be performed with regard to the computer network to address the anomalies without receiving an indication that an anomaly similar to the plurality of anomalies has yet occurred at the local computer network.

The following examples illustrate how a respective local anomaly detection system 102 may utilizing the disclosed centralized anomaly awareness system 112 in detecting anomalies and protecting a local computer network 104 (or a monitored component 110 thereof).

An external user may access a large number of sensitive files (e.g., network components 110) located on servers or databases in Korea, France, and India. The local anomaly detection system 102 for each country may aggregate these file access events; that is, track the number of sensitive file accesses in each country. If the number passes a first threshold pertaining to the respective local system (e.g., 1000 accesses) then the local system (e.g., event aggregator module L2) reports the aggregation to the centralized awareness server (e.g., global aggregator module G1), which then reports the anomaly to each other local system 102. Each respective local system may have a different policy as to how to handle remediation. The Korean and Indian systems 102 may decide as result to remediate by revoking user access to their files, while the French system 102 may decide to send the suspected access to a local security operations center (e.g., admin account) for review.

In another example, an external user may fail to login to multiple data sources (e.g., network components 110) over a certain number of times (e.g., >10) in an hour. In this regard, an attacker may have compromised an organizational computer and is trying to brute-force user password by attempting it on different file servers in France, UK & US. The attacker then spreads the attack over multiple servers to try to login only 5 times to each, to go undetected of a system that triggers alert for over 10 bad login attempts. Each local anomaly detection system 102 per country counts 5 bad login attempts but may not individually see an anomaly, but the system may report the attempts to the centralized awareness server (e.g., global aggregator module G1) on a lower threshold of 5 attempts. The number of failed logins is counted and sent to the centralized awareness server which further aggregates them and reports the total running count back to each local system 102. The total reported becomes 15 bad attempts, which now triggers the local system to detect an anomaly (e.g., at the anomaly detection module L3). An alert may then be generated locally and a remediation action taken, so that the computer from which the attempts originate is suspended and deep malware scan is triggered.

In another example, a computer on the Internet performs scraping or other illegitimate activity against multiple web sites (e.g., network components 110), while making sure to limit its rate to a slow rate of requests to avoid detection. Each local web site protection system counts suspicious bot-like activity and reports it to the centralized anomaly awareness system 112, which aggregates it and distributes back to each local anomaly detection system 102. Since together number of bot-like behaviors is high and satisfies the threshold for local anomaly detection, the network address of the computer performing the activity may be flagged as a bot. A remediation action may then be applied by each local anomaly detection system 102, causing its web application firewall to block the network address of the computer.

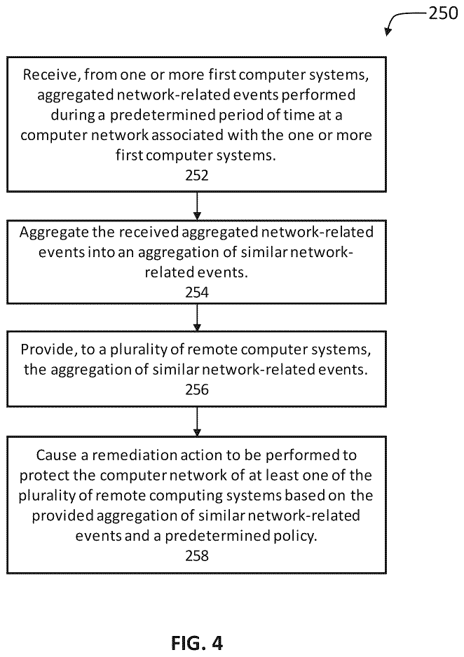

FIG. 4 depicts a second example process flow diagram for protecting local computer networks from anomalous network behavior using a centralized anomaly awareness system, according to aspects of the subject technology. For explanatory purposes, the various blocks of example process 250 are described herein with reference to FIGS. 1-3 and the components and/or processes described herein. One or more of the blocks of process 300 may be implemented, for example, by one or more servers or computing devices, such as the disclosed centralized anomaly awareness system 112. In some implementations, one or more of the blocks may be implemented apart from other blocks, and by one or more different processors (including virtual processors) or devices. Further for explanatory purposes, the blocks of example process 250 are described as occurring in serial, or linearly. However, multiple blocks of example process 250 may occur in parallel. In addition, the blocks of example process 250 need not be performed in the order shown and/or one or more of the blocks of example process 250 need not be performed.

In the depicted example, a centralized anomaly awareness system 112 receives aggregated network-related events from one or more first computer systems; for example, from one or more connected anomaly detection systems 102. According to various implementations, the aggregated network-related events is an aggregation of events detected at a local organization's computer network 104 that were performed during a predetermined period of time and which pertain to actions originating from outside the computer network.

The centralized anomaly awareness system 112 aggregates the received aggregated network-related events into an aggregation of similar network-related events (254), and provides the aggregation to a plurality of remote computer systems; for example, to all connected local anomaly detection systems 102.

A remediation action is then caused to be performed to protect the local organization's computer network 104 (258). According to various implementations, the remediation action is performed by the one or more connected anomaly detection systems 102. In some implementations, the centralized anomaly awareness system 112 may identify to the one or more connected anomaly detection systems 102 a plurality of related anomalous attacks originating from a common entity. In this regard, as described previously, the centralized anomaly awareness system 112 receives indications of anomalous attacks from other connected anomaly detection systems 102, and provides indications of the anomalous attacks back to the local systems 102. The indications may include, for example, contextual information about the anomalies seen in other systems. For example, the contextual information may include a period of time in which the attacks were detected (or received), an identification of the common entity responsible for the plurality of related anomalous attacks, an anonymous description of the organization whose network was the subject of the attack (e.g., “a bank in the northwest United States”). In this manner, the local system 102 may select a remediation action suitable for addressing the anomaly in response to receiving the information.

Many of the above-described example steps of processes 200 and 300, and related features and applications, may also be implemented as software processes that are specified as a set of instructions recorded on a computer readable storage medium (also referred to as computer readable medium), and may be executed automatically (e.g., without user intervention). Any or all of the foregoing steps may be performed by a machine, automatically. That is, the step(s) may be performed without user involvement or action, for example, according to a predetermined programmed schedule or in response to a preceding action. When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

The term “software” is meant to include, where appropriate, firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

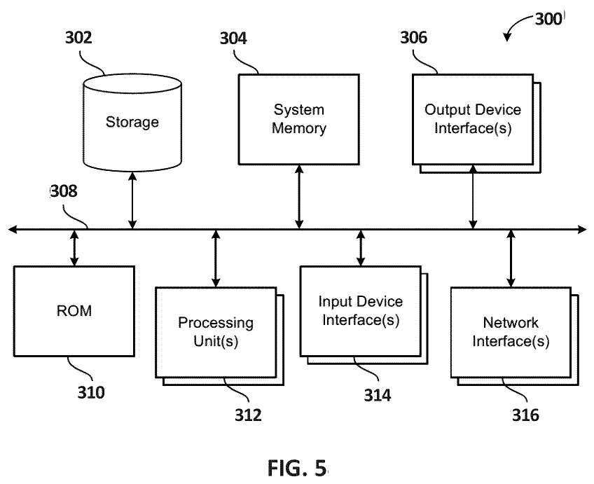

FIG. 5 is a conceptual diagram illustrating an example electronic system for protecting local computer networks from anomalous network behavior using a centralized anomaly awareness system, according to aspects of the subject technology. Electronic system 300 may be a specifically configured computing device for execution of software associated with one or more portions or steps of process 300, or components and processes provided by FIGS. 1 through 4, including but not limited to one or more computing devices implementing a respective local anomaly detection system 102 or the centralized anomaly awareness system 112. Such devices may include or be associated with an user endpoint device, internal server, edge device, or external application server. Electronic system 300 may be or include a server, a personal computer or a mobile device such as a smartphone, tablet computer, laptop, PDA, an augmented reality device, a wearable such as a watch or band or glasses, or combination thereof, or other touch screen or television with one or more processors embedded therein or coupled thereto, or any other sort of computer-related electronic device having network connectivity.

Electronic system 300 may include various types of computer readable media and interfaces for various other types of computer readable media. In the depicted example, electronic system 300 includes a bus 308, processing unit(s) 312, a system memory 304, a read-only memory (ROM) 310, a permanent storage device 302, an input device interface 314, an output device interface 306, and one or more network interfaces 316. In some implementations, electronic system 300 may include or be integrated with other computing devices or circuitry for operation of the various components and processes previously described.

Bus 308 collectively represents all system, peripheral, and chipset buses that communicatively connect the numerous internal devices of electronic system 300. For instance, bus 308 communicatively connects processing unit(s) 312 with ROM 310, system memory 304, and permanent storage device 302.

From these various memory units, processing unit(s) 312 retrieves instructions to execute and data to process, in order to execute the processes of the subject disclosure. The processing unit(s) can be a single processor or a multi-core processor in different implementations.

ROM 310 stores static data and instructions that are needed by processing unit(s) 312 and other modules of the electronic system. Permanent storage device 302, on the other hand, is a read-and-write memory device. This device is a non-volatile memory unit that stores instructions and data even when electronic system 300 is off. Some implementations of the subject disclosure use a mass-storage device (such as a magnetic or optical disk and its corresponding disk drive) as permanent storage device 302.

Other implementations use a removable storage device (such as a floppy disk, flash drive, and its corresponding disk drive) as permanent storage device 302. Like permanent storage device 302, system memory 304 is a read-and-write memory device. However, unlike storage device 302, system memory 304 is a volatile read-and-write memory, such as a random access memory. System memory 304 stores some of the instructions and data that the processor needs at runtime. In some implementations, the processes of the subject disclosure are stored in system memory 304, permanent storage device 302, and/or ROM 310. From these various memory units, processing unit(s) 312 retrieves instructions to execute and data to process in order to execute the processes of some implementations.

Bus 308 also connects to input and output device interfaces 314 and 306. Input device interface 314 enables the user to communicate information and select commands to the electronic system. Input devices used with input device interface 314 include, e.g., alphanumeric keyboards and pointing devices (also called “cursor control devices”). Output device interfaces 306 enables, e.g., the display of images generated by the electronic system 300. Output devices used with output device interface 306 include, e.g., printers and display devices, such as cathode ray tubes (CRT) or liquid crystal displays (LCD). Some implementations include devices such as a touchscreen that functions as both input and output devices.

Also, as shown in FIG. 5, bus 308 also couples electronic system 300 to a network (not shown) through network interfaces 316. Network interfaces 316 may include, e.g., a wireless access point (e.g., Bluetooth or WiFi) or radio circuitry for connecting to a wireless access point. Network interfaces 316 may also include hardware (e.g., Ethernet hardware) for connecting the computer to a part of a network of computers such as a local area network (“LAN”), a wide area network (“WAN”), wireless LAN, or an Intranet, or a network of networks, such as the Internet. Any or all components of electronic system 300 can be used in conjunction with the subject disclosure.

Each network connections disclosed herein may be a wired or wireless connection, such as by Ethernet, WiFi, BLUETOOTH, an integrated services digital network (ISDN) connection, a digital subscriber line (DSL) modem, or a cable modem. Direct or indirect network connection may be used, including, but not limited to a telephone modem, an MIB system, an RS232 interface, an auxiliary interface, an optical link, an infrared link, a radio frequency link, a microwave link, a personal area network connection, a local area network connection, a cellular link, or a WLANS connection or other wireless connection.

Enterprise devices incorporating aspects of the subject technology may be equipped with a network interface module (NIM), allowing each device to participate as a node in a network. While for purposes of clarity the subject technology will be described as operating in an Ethernet network environment using the Internet Protocol (IP), it is understood that concepts of the subject technology are equally applicable in other network environments, and such environments are intended to be within the scope of the subject technology.

Data to and from the various data sources can be converted into network-compatible data with existing technology, and movement of the information between the appliances and the network can be accomplished by a variety of means. For example, the appliances and network may communicate via automated interaction, manual interaction, or a combination of both automated and manual interaction. Automated interaction may be continuous or intermittent and may occur through direct network connection, or through RS232 links, MIB systems, RF links such as BLUETOOTH, IR links, PANS, LANS, WLANS, digital cable systems, telephone modems or other wired or wireless communication means. The communication means in various aspects may be bidirectional with access to data from as many points of the distributed data sources as possible. Decision-making can occur at a variety of places within the network.

These functions described above can be implemented in computer software, firmware, or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (also referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to specifically configured electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; e.g., feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; e.g., by sending web pages to a web browser on a user's client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and may interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. The described functionality may be implemented in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

### Illustration of Subject Technology as Clauses:

Various examples of aspects of the disclosure are described as numbered clauses (1, 2, 3, etc.) for convenience. These are provided as examples, and do not limit the subject technology. Identifications of the figures and reference numbers are provided below merely as examples and for illustrative purposes, and the clauses are not limited by those identification.
Clause 1. A computer-implemented method for protecting a computer network from anomalous network behavior, comprising: aggregating similar network-related events performed during a predetermined period of time at a computer network and that pertain to actions originating from outside the computer network; reporting the aggregated network-related events to a remote centralized analytics server when the aggregated network-related events satisfies a first threshold number of events; receiving, from the remote centralized analytics server, an indication of an additional aggregation of the similar network-related events performed at one or more different computer networks; determining an anomaly based on a sum of the aggregated network-related events and the additional aggregation satisfying a second threshold number of events; automatically selecting a remediation action to be performed with regard to the computer network based on the determined anomaly and a predetermined policy; and automatically performing the remediation action to protect the computer network.
Clause 2. The computer-implemented method of Clause 1, wherein each similar network-related event comprises an initiation of access to the computing network, and wherein reporting the aggregated network-related events comprises reporting an identification of one or more entities responsible for the actions originating from outside the computer network.
Clause 3. The computer-implemented method of Clause 2, wherein the identification includes a network address of a computer system.
Clause 4. The computer-implemented method of any of Clauses 1-3, further comprising: reporting the determined anomaly to the remote centralized analytics server; receiving, from the remote centralized analytics server, an indication of one or more incidents of the determined anomaly being reported by one or more other anonymous organizations geographically remote from the computer network; and generating a notification pertaining to the remediation action and comprising information pertaining to the one or more incidents of the determined anomaly being reported by the one or more anonymous other organizations.
Clause 5. The computer-implemented method of Clause 4, wherein the remediation action is selected based on, in part, the one or more incidents being reported by the one or more other anonymous organizations.
Clause 6. The computer-implemented method of any of Clauses 1-5, wherein each network-related event comprises a connection attempt from a common network address, and the remediation action comprises configuring a firewall associated with the computer network to block connection attempts originating from the common network address; or wherein each network-related event comprises a user access to a number of sensitive files, and the remediation action comprises preventing further user access; or wherein each network-related event comprises a failed attempt to login to a same user account, and the remediation action comprises blocking further login attempts to the same user account.
Clause 7. The computer-implemented method of any of Clauses 1-6, further comprising: receiving, from the remote centralized analytics server, an indication of a plurality of anomalies being reported by computers outside of and remote from the computer network; and automatically performing a remediation action with regard to the computer network to address the plurality of anomalies without receiving an indication that an anomaly similar to the plurality of anomalies has occurred at the computer network.
Clause 8. The computer-implemented method of any of Clauses 1-7, wherein the second threshold number of events is greater than the first threshold number of events.
Clause 9. A computer-implemented method comprising: receiving, from one or more first computer systems of a plurality of remote computer systems, aggregated network-related events performed during a predetermined period of time at a computer network associated with the one or more first computer systems that pertain to actions originating from outside the computer network; aggregating the received aggregated network-related events into an aggregation of similar network-related events; providing, to the plurality of remote computer systems, the aggregation of similar network-related events; and causing a remediation action to be performed to protect the computer network of at least one of the plurality of remote computing systems based on the provided aggregation of similar network-related events and a predetermined policy.
Clause 10. The computer-implemented method of Clause 9, further comprising: receiving, from one or more second computer systems of the plurality of remote computer systems, an indication of an anomalous attack at a computer network associated with the one or more second computer systems; identifying a plurality of related anomalous attacks originating from a common entity; and providing, to the plurality of remote computer systems, an identification of the related anomalous attacks and an identification of the common entity responsible for the plurality of related anomalous attacks.
Clause 11. A system for protecting a computer network from anomalous network behavior, comprising: a non-transitory machine readable medium comprising instructions stored thereon; one or more computing devices operably connected to a computer network and configured to execute the instructions and perform operations comprising: aggregating similar network-related events performed during a predetermined period of time at the computer network and that pertain to actions originating from outside the computer network; reporting the aggregated network-related events to a centralized analytics server, remote from the one or more computing devices, when the aggregated network-related events satisfies a first threshold number of events; receiving, from the centralized analytics server, an indication of an additional aggregation of the similar network-related events performed at one or more different computer networks; determining an anomaly based on a sum of the aggregated network-related events and the additional aggregation satisfying a second threshold number of events; automatically selecting a remediation action to be performed with regard to the computer network based on the determined anomaly and a predetermined policy; and automatically performing the remediation action to protect the computer network.
Clause 12. The system of Clause 11, wherein each similar network-related event comprises an initiation of access to the computing network, and wherein reporting the aggregated network-related events comprises reporting an identification of one or more entities responsible for the actions originating from outside the computer network.
Clause 13. The system of Clause 12, wherein the identification includes a network address of a computer system.
Clause 14. The system of any of Clauses 11-13, wherein the operations further comprise: reporting the determined anomaly to the centralized analytics server; receiving, from the centralized analytics server, an indication of one or more incidents of the determined anomaly being reported by one or more other anonymous organizations geographically remote from the computer network; and generating a notification pertaining to the remediation action and comprising information pertaining to the one or more incidents of the determined anomaly being reported by the one or more other anonymous organizations.
Clause 15. The system of Clause 14, wherein the remediation action is selected based on, in part, the one or more incidents being reported by the one or more other anonymous organizations.
Clause 16. The system of any of Clauses 11-15, wherein each network-related event comprises a connection attempt from a common network address, and the remediation action comprises configuring a firewall associated with the computer network to block connection attempts originating from the common network address; or wherein each network-related event comprises a user access to a number of sensitive files, and the remediation action comprises preventing further user access; or wherein each network-related event comprises a failed attempt to login to a same user account, and the remediation action comprises blocking further login attempts to the same user account.
Clause 17. The system of any of Clauses 11-16, wherein the operations further comprise: receiving, from the centralized analytics server, an indication of a plurality of anomalies being reported by computers outside of and remote from the computer network; and automatically performing a remediation action with regard to the computer network to address the plurality of anomalies without receiving an indication that an anomaly similar to the plurality of anomalies has occurred at the computer network.
Clause 18. The system of any of Clauses 11-17, wherein the second threshold number of events is greater than the first threshold number of events.
Clause 19. The system of any of Clauses 11-18, further comprising: the centralized analytics server, the centralized analytics server configured to perform server operations comprising: receiving, from one or more first computer systems including the one or more computing devices, aggregated network-related events performed during a predetermined period of time at a computer network associated with the one or more first computer systems that pertain to actions originating from outside the computer network; aggregating the received aggregated network-related events into the aggregation of similar network-related events; providing, to a plurality of remote computer systems including the one or more computing devices, the aggregation of similar network-related events; and wherein the remediation action is performed based on the provided aggregation of similar network-related events and the predetermined policy.
Clause 20. The system of Clause 19, wherein the server operations further comprise: receiving, from one or more second computer systems of the plurality of remote computer systems, an indication of an anomalous attack at a computer network associated with the one or more second computer systems; and identifying a plurality of related anomalous attacks originating from a common entity; and providing, to the plurality of remote computer systems, an identification of the related anomalous attacks and an identification of the common entity responsible for the plurality of related anomalous attacks.

### Further Considerations:

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention described herein.

The term website, as used herein, may include any aspect of a website, including one or more web pages, one or more servers used to host or store web related content, etc. Accordingly, the term website may be used interchangeably with the terms web page and server. The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

The term automatic, as used herein, may include performance by a computer or machine without user intervention; for example, by instructions responsive to a predicate action by the computer or machine or other initiation mechanism. The word “example” is used herein to mean “serving as an example or illustration.” Any aspect or design described herein as “example” is not necessarily to be construed as preferred or advantageous over other aspects or designs.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “implementation” does not imply that such implementation is essential to the subject technology or that such implementation applies to all configurations of the subject technology. A disclosure relating to an implementation may apply to all implementations, or one or more implementations. An implementation may provide one or more examples. A phrase such as an “implementation” may refer to one or more implementations and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

What is claimed is:

1. A computer-implemented method for protecting a computer network from anomalous network behavior, comprising:
aggregating similar network-related events performed during a predetermined period of time at a computer network and that pertain to actions originating from outside the computer network;
reporting the aggregated network-related events to a remote centralized analytics server when the aggregated network-related events satisfies a first threshold number of events;
receiving, from the remote centralized analytics server, an indication of an additional aggregation of the similar network-related events performed at one or more different computer networks;
determining an anomaly based on a sum of the aggregated network-related events and the additional aggregation satisfying a second threshold number of events;
automatically selecting a remediation action to be performed with regard to the computer network based on the determined anomaly and a predetermined policy; and
automatically performing the remediation action to protect the computer network.

2. The computer-implemented method of claim 1,
wherein each similar network-related event comprises an initiation of access to the computing network, and
wherein reporting the aggregated network-related events comprises reporting an identification of one or more entities responsible for the actions originating from outside the computer network.

3. The computer-implemented method of claim 2,
wherein the identification includes a network address of a computer system.

4. The computer-implemented method of claim 1, further comprising:
reporting the determined anomaly to the remote centralized analytics server;
receiving, from the remote centralized analytics server, an indication of one or more incidents of the determined anomaly being reported by one or more other anonymous organizations geographically remote from the computer network; and
generating a notification pertaining to the remediation action and comprising information pertaining to the one or more incidents of the determined anomaly being reported by the one or more anonymous other organizations.

5. The computer-implemented method of claim 4,
wherein the remediation action is selected based on, in part, the one or more incidents being reported by the one or more other anonymous organizations.

6. The computer-implemented method of claim 1,
wherein each network-related event comprises a connection attempt from a common network address, and the remediation action comprises configuring a firewall associated with the computer network to block connection attempts originating from the common network address; or
wherein each network-related event comprises a user access to a number of sensitive files, and the remediation action comprises preventing further user access; or
wherein each network-related event comprises a failed attempt to login to a same user account, and the remediation action comprises blocking further login attempts to the same user account.

7. The computer-implemented method of claim 1, further comprising:
receiving, from the remote centralized analytics server, an indication of a plurality of anomalies being reported by computers outside of and remote from the computer network; and
automatically performing a remediation action with regard to the computer network to address the plurality of anomalies without receiving an indication that an anomaly similar to the plurality of anomalies has occurred at the computer network.

8. The computer-implemented method of claim 1, wherein the second threshold number of events is greater than the first threshold number of events.

9. A computer-implemented method comprising:
receiving, from one or more first computer systems of a plurality of remote computer systems, aggregated network-related events performed during a predetermined period of time at a computer network associated with the one or more first computer systems that pertain to actions originating from outside the computer network;
aggregating the received aggregated network-related events into an aggregation of similar network-related events;
providing, to the plurality of remote computer systems, the aggregation of similar network-related events; and
causing a remediation action to be performed to protect the computer network of at least one of the plurality of remote computing systems based on the provided aggregation of similar network-related events and a predetermined policy.

10. The computer-implemented method of claim 9, further comprising:
receiving, from one or more second computer systems of the plurality of remote computer systems, an indication of an anomalous attack at a computer network associated with the one or more second computer systems;
identifying a plurality of related anomalous attacks originating from a common entity; and
providing, to the plurality of remote computer systems, an identification of the related anomalous attacks and an identification of the common entity responsible for the plurality of related anomalous attacks.

11. A system for protecting a computer network from anomalous network behavior, comprising:
a non-transitory machine readable medium comprising instructions stored thereon;
one or more computing devices operably connected to a computer network and configured to execute the instructions and perform operations comprising:
aggregating similar network-related events performed during a predetermined period of time at the computer network and that pertain to actions originating from outside the computer network;
reporting the aggregated network-related events to a centralized analytics server, remote from the one or more computing devices, when the aggregated network-related events satisfies a first threshold number of events;
receiving, from the centralized analytics server, an indication of an additional aggregation of the similar network-related events performed at one or more different computer networks;
determining an anomaly based on a sum of the aggregated network-related events and the additional aggregation satisfying a second threshold number of events;
automatically selecting a remediation action to be performed with regard to the computer network based on the determined anomaly and a predetermined policy; and
automatically performing the remediation action to protect the computer network.

12. The system of claim 11,
wherein each similar network-related event comprises an initiation of access to the computing network, and
wherein reporting the aggregated network-related events comprises reporting an identification of one or more entities responsible for the actions originating from outside the computer network.

13. The system of claim 12,
wherein the identification includes a network address of a computer system.

14. The system of claim 11, wherein the operations further comprise:
reporting the determined anomaly to the centralized analytics server;
receiving, from the centralized analytics server, an indication of one or more incidents of the determined anomaly being reported by one or more other anonymous organizations geographically remote from the computer network; and
generating a notification pertaining to the remediation action and comprising information pertaining to the one or more incidents of the determined anomaly being reported by the one or more other anonymous organizations.

15. The system of claim 14,
wherein the remediation action is selected based on, in part, the one or more incidents being reported by the one or more other anonymous organizations.

16. The system of claim 11,
wherein each network-related event comprises a connection attempt from a common network address, and the remediation action comprises configuring a firewall associated with the computer network to block connection attempts originating from the common network address; or
wherein each network-related event comprises a user access to a number of sensitive files, and the remediation action comprises preventing further user access; or
wherein each network-related event comprises a failed attempt to login to a same user account, and the remediation action comprises blocking further login attempts to the same user account.

17. The system of claim 11, wherein the operations further comprise:
receiving, from the centralized analytics server, an indication of a plurality of anomalies being reported by computers outside of and remote from the computer network; and
automatically performing a remediation action with regard to the computer network to address the plurality of anomalies without receiving an indication that an anomaly similar to the plurality of anomalies has occurred at the computer network.

18. The system of claim 11, wherein the second threshold number of events is greater than the first threshold number of events.

19. The system of claim 11, further comprising:
the centralized analytics server, the centralized analytics server configured to perform server operations comprising:
receiving, from one or more first computer systems including the one or more computing devices, aggregated network-related events performed during a predetermined period of time at a computer network associated with the one or more first computer systems that pertain to actions originating from outside the computer network;
aggregating the received aggregated network-related events into the aggregation of similar network-related events;
providing, to a plurality of remote computer systems including the one or more computing devices, the aggregation of similar network-related events; and
wherein the remediation action is performed based on the provided aggregation of similar network-related events and the predetermined policy.

20. The system of claim 19, wherein the server operations further comprise:
receiving, from one or more second computer systems of the plurality of remote computer systems, an indication of an anomalous attack at a computer network associated with the one or more second computer systems; and
identifying a plurality of related anomalous attacks originating from a common entity; and
providing, to the plurality of remote computer systems, an identification of the related anomalous attacks and an identification of the common entity responsible for the plurality of related anomalous attacks.
